(19) United States
(12) Patent Application Publication
(10) Pub. No.: US 2025/0008376 A1
(43) Pub. Date: Jan. 2, 2025

(54) METHOD AND DEVICE FOR MANAGING QUALITY OF SERVICE OF TRAFFIC IN WIRELESS COMMUNICATION SYSTEM

(71) Applicant: Samsung Electronics Co., Ltd., Gyeonggi-do (KR)

(72) Inventor: Dongyeon KIM, Gyeonggi-do (KR)

(21) Appl. No.: 18/693,264

(22) PCT Filed: Oct. 20, 2022
(86) PCT No.: PCT/KR2022/016080

§ 371 Date: Mar. 19, 2024

(30) Foreign Application Priority Data
Oct. 20, 2021 (KR) 10-2021-0140623

(51) Int. Cl. H04W 28/08; H04W 24/02

(52) U.S. Cl. CPC H04W 28/0942; H04W 24/02; H04W 28/0846

(57) ABSTRACT

The present disclosure relates to a 5G or 6G communication system for supporting a higher data transmission rate. A method by which a first entity performs a policy control function (PCF) in a wireless communication system, according to one embodiment of the present disclosure, comprises the steps of: sensing the need for determination of a policy control function with respect to the first entity; transmitting a data analysis information request message for determination of the policy control function to a second entity performing a network data analytics function (NWDAF) on the basis of the sensing result; receiving data analysis information from the second entity; and determining the policy control function on the basis of the data analysis information, wherein the data analysis information is determined on the basis of a data access type.

### TECHNICAL FIELD

The disclosure relates to a method and a device for managing a quality of service in a wireless communication system or a mobile communication system, and more particularly to a method and a device for providing access traffic steering, switching, and splitting (ATSSS) in a wireless communication system.

### BACKGROUND ART

A 5G mobile communication technology defines a wide frequency band to make a fast transmission speed and a new service possible, and can be implemented not only in a frequency band equal to or lower than 6 GHz (“Sub 6 GHz”), such as 3.5 GHz, but also in an ultrahigh frequency band (“Above 6 GHz”) called millimeter waves (mmWave), such as 28 GHz or 39 GHz. Further, in case of a 6G mobile communication technology called a beyond 5G system, in order to achieve the transmission speed that is 50 times higher than that of the 5G mobile communication technology and ultralow latency that is reduced to 1/10 of the latency of the 5G mobile communication technology, implementation of the 6G mobile communication technology in the terahertz band (e.g., the band in the range of 95 GHz to 3 terahertz (3 THz)) has been considered.

At the beginning of the 5G mobile communication technology, with the aim of supporting services for enhanced mobile broadband (eMBB), ultra-reliable low-latency communications (URLLC), and massive machine-type communications (mMTC) and satisfying performance requirements, standardization has been carried out for beamforming and massive MIMO to mitigate a path loss of radio waves in an ultrahigh frequency band and to increase a transfer distance of the radio waves, various numerology supports (operation of a plurality of subcarrier spacings and so on) for efficient utilization of ultrahigh frequency resources and a dynamic operation for a slot format, an initial access technology for supporting multi-beam transmission and broadband, definition and operation of a band-width part (BWP), a new channel coding method, such as a polar code for highly reliable transmission of a low density parity check (LDPC) code and control information for mass data transmission, L2 preprocessing, and network slicing for providing a dedicated network specialized for a specific service.

At present, in consideration of services intended to be supported by the 5G mobile communication technology, discussions for the initial 5G mobile communication technology improvement and performance enhancement are underway, and the physical layer standardization has been carried out for technologies of vehicle-to-everything (V2X) to help the driving judgment of an autonomous vehicle and to increase user convenience based on the vehicle location and state information being transmitted by the vehicle itself, a new radio unlicensed (NR-U) for the purpose of a system operation to meet the requirements on various regulations in an unlicensed band, NR UE power saving, a non-terrestrial network (NTN) that is a UE-satellite direct communication for securing a coverage in an area where communication with a ground network is not possible, and positioning.

In addition, standardization in the field of a wireless interface architecture/protocol has also been carried out for technologies of the industrial internet of things (IIoT) for a new service support through linking and fusion with other industries, an integrated access and backhaul (IAB) to provide a node for extending a network service area through an integrated support of a wireless backhaul link and an access link, mobility enhancement including a conditional handover and a dual active protocol stack (DAPS) handover, and a 2-step random access (2-step RACH for NR) to simplify a random access procedure, and standardization in the field of a system architecture/service has also been carried out for a 5G base line architecture (e.g., service based architecture and service based interface) for grafting of network functions virtualization (NFV) and software-defined networking (SDN) technologies, and mobile edge computing (MEC) for being provided with a service based on a UE location.

If the 5G mobile communication system as described above is commercialized, it is expected that connected devices, which are on an explosive growth trend, will be connected to a communication network, and accordingly, it will be necessary to enhance the function and performance of the 5G mobile communication system and to perform an integrated operation of the connected devices. For this, new researches are scheduled to be performed for the 5G performance improvement and complexity reduction by utilizing the extended reality (XR) for efficiently supporting augmented reality (AR), virtual reality (VR), and mixed reality (MR), artificial intelligence (AI), and machine learning (ML), AI service support, meta bus service support, and drone communication.

Further, the development of the 5G mobile communication system will be able to become the basis for developments of not only the multi-antenna transmission technology, such as new waveforms, full dimension MIMO (FD-MIMO), array antennas, and large scale antennas, to secure the coverage in a terahertz band of a 6G mobile communication technology, lenses and antennas based on meta materials to improve the coverage of the terahertz band signal, high-dimensional space multiplexing technology using orbital angular momentum (OAM), and reconfigurable intelligent surface (RIS) technology, but also full duplex technology for frequency efficiency enhancement and system network improvement of the 6G mobile communication technology, AI-based communication technology to realize system optimization through utilization of a satellite and artificial intelligence (AI) from a design stage and internalization of an end-to-end AI support function, and next generation distributed computing technology to realize a service having complexity that exceeds the limits of UE computation capability by utilizing the ultrahigh performance communication and computing resources.

### DISCLOSURE OF INVENTION

### Technical Problem

In a 5G system, an ATSSS function is a technology to provide a method for reducing a transmission load through dispersion of data traffics between a data network (DN) and user equipment (UE) by simultaneously using a 3GPP access and a non-3GPP access. A policy control function (PCF) that constitutes a 5G core network may determine an ATSSS function related policy including a data traffic steering mode, a steering functionality, and so on. The determined ATSSS function related policy may be included in the session management policy and may be transferred to a session management function (SMF). In determining the ATSSS function-related policy, the PCF may refer to service requirements received from an application function (AF).

The SMF may determine the ATSSS function-related information including the data traffic steering mode, steering functionality, and address information necessary for traffic transmission and reception, and may transfer the ATSSS function related information to a UE and a user plane function (UPF). In determining the ATSSS function-related information, the SMF may refer to the session management policy transferred from the PCF. The address information necessary for the traffic transmission and reception may include a UE IP address, a UPF IP address, and a UPF UDP port number. Before transmitting the ATSSS function related information to the UPF and the UE, the SMF may request the UPF to allocate the UP IP address, UPF IP address, and UPF UDP port number, and may include the address information received from the UPF in the ATSSS function related information.

In the 5G system up to now, in determining a data traffic transmission method including determination of an access path to be used for one multi-access (MA) PDU session, determination of a traffic amount to be sent through each access pat, and/or determination of a target traffic to be sent through each access path, it has been preferred to determine the method based on the policy determined by the PCF. Further, before the PCF determines a new policy again, the UE and the UPF have determined the data traffic transmission method in accordance with the last received ATSSS function related policy.

In this case, since the real time UE state and network state are not reflected, a service quality deterioration problem in that a communication service is cut off before the UE and the network receive the new policy may occur.

An aspect of the disclosure is to provide a method and a device for determining a data traffic transmission method based on UE state and network state information in case that a UE uses a service by using a 5G core network and an MA PDU session in a wireless communication system.

Another aspect of the disclosure is to provide a method and a device for increasing a quality of service when a service is provided to a UE by using an MA PDU session in a wireless communication system.

Still another aspect of the disclosure is to provide a method and a device in which a PCF efficiently determines policy control and charging rules in consideration of a quality of service for each access type in a wireless communication system.

### Solution to Problem

In order to solve the above problems, according to an embodiment of the disclosure, a method performed by a first entity for performing a policy control function (PCF) in a wireless communication system includes: detecting a need for determination of a policy control function with respect to the first entity, transmitting data analysis information request message for determination of the policy control function to a second entity configured to perform a network data analytics function (NWDAF) based on the detection result; receiving data analysis information from the second entity; and determining the policy control function based on the data analysis information, wherein the data analysis information is determined based on a data access type.

In order to solve the above problems, according to an embodiment of the disclosure, a method performed by a third entity for performing a user plane function (UPF) in a wireless communication system includes: receiving a data transmission performance request message from a second entity configured to perform a network data analytics function (NWDAF); obtaining a result of data transmission performance measurement; and transmitting the result of data transmission performance measurement to the second entity, wherein the data transmission performance is determined based on a data access type.

In order to solve the above problems, according to an embodiment of the disclosure, a method performed by a second entity for performing a network data analytics function (NWDAF) in a wireless communication system includes: receiving a data analysis information request message for changing a policy control function (PCF) from a first entity configured to perform the policy control function; transmitting a data transmission performance request message to a third entity configured to perform a user plane function (UPF) based on the data analysis information request message; receiving a result of data transmission performance measurement from the third entity; and transmitting data analysis information to the first entity based on the result of data transmission performance measurement, wherein the data analysis information and the data transmission performance are determined based on a data access type.

In order to solve the above problems, according to an embodiment of the disclosure, a first entity for performing a policy control function (PCF) in a wireless communication system includes: a transceiver configured to transmit and receive a signal; and a controller connected to the transceiver, wherein the controller is configured to: detect a need for determination of a policy control function with respect to the first entity, transmit data analysis information request message for determination of the policy control function to a second entity configured to perform a network data analytics function (NWDAF) based on the detection result, receive data analysis information from the second entity, and determine the policy control function based on the data analysis information, wherein the data analysis information is determined based on a data access type.

In order to solve the above problems, according to an embodiment of the disclosure, a third entity for performing a user plane function (UPF) in a wireless communication system includes: a transceiver configured to transmit and receive a signal; and a controller connected to the transceiver, wherein the controller is configured to: receive a data transmission performance request message from a second entity configured to perform a network data analytics function (NWDAF), obtaining a result of data transmission performance measurement, and transmit the result of data transmission performance measurement to the second entity, wherein the data transmission performance is determined based on a data access type. In order to solve the above problems, according to an embodiment of the disclosure, a second entity for performing a network data analytics function (NWDAF) in a wireless communication system includes: a transceiver configured to transmit and receive a signal; and
a controller connected to the transceiver, wherein the controller is configured to: receive a data analysis information request message for changing a policy control function (PCF) from a first entity configured to perform the policy control function, transmit a data transmission performance request message to a third entity configured to perform a user plane function (UPF) based on the data analysis information request message, receive a result of data transmission performance measurement from the third entity, and transmit data analysis information to the first entity based on the result of data transmission performance measurement, wherein the data analysis information and the data transmission performance are determined based on a data access type.

### Advantageous Effects of Invention

According to an embodiment of the disclosure, in case that the UE uses the service by using the 5G core network and the MA PDU session in the wireless communication system, the UE and/or network may determine the optimum traffic transmission path by using a deep network model based on the service, application information, network state, and performance analysis information, and thus the data traffic transmission performance can be improved.

Further, according to an embodiment of the disclosure, the policy control and charging rules can be efficiently determined in consideration of the quality of service for each access type.

Effects that can be obtained in the disclosure are not limited to the above-mentioned effects, and other unmentioned effects will be able to be clearly understood by those of ordinary skill in the art to which the disclosure pertains from the following description.

### BRIEF DESCRIPTION OF DRAWINGS

FIG. 1 is a diagram illustrating the structure of a 5G system according to an embodiment of the disclosure.

FIG. 2 is a diagram exemplifying the structure of a 5G system for supporting an ATSSS function related to an embodiment of the disclosure.

FIG. 3 is a diagram illustrating the structure of a deep reinforcement learning model related to an embodiment of the disclosure.

FIG. 4 is a diagram exemplifying the structure of a 5G system for providing ATSSS according to an embodiment of the disclosure.

FIG. 5 is a diagram exemplifying the structure of a 5G system for performing ATSSS according to an embodiment of the disclosure.

FIG. 6 is a diagram exemplifying a connection between NWDAF for providing ATSSS and another NF according to an embodiment of the disclosure.

FIG. 7 is a diagram exemplifying a connection between NWDAF for providing ATSSS and another NF according to an embodiment of the disclosure.

FIG. 8 is a diagram illustrating a first embodiment in which an entity that performs a policy control function (PCF) by using a network data analysis performs a policy control and charging (PCC) rules determination procedure.

FIG. 9 is a diagram illustrating a second embodiment in which an entity that performs a policy control function (PCF) by using a network data analysis performs a policy control and charging (PCC) rules determination procedure.

FIG. 10 is a diagram illustrating a third embodiment in which an entity that performs a policy control function (PCF) by using a network data analysis performs a policy control and charging (PCC) rule determination procedure.

FIG. 11 is a diagram illustrating a fourth embodiment in which an entity that performs a policy control function (PCF) by using a network data analysis performs a policy control and charging (PCC) rule determination procedure.

FIG. 12 is a diagram illustrating the structure of a UE according to an embodiment of the disclosure.

FIG. 13 is a diagram illustrating the structure of a device capable of implementing NF according to an embodiment of the disclosure.

### MODE FOR THE INVENTION

Hereinafter, preferred embodiments of the disclosure will be described in detail with reference to the accompanying drawings. In the accompanying drawings, it is to be noted that the same constituent elements are represented by the same symbols as possible. Further, the accompanying drawings of the disclosure are provided to help understanding of the disclosure, and it is to be noted that the disclosure is not limited to the shape or disposition exemplified in the drawings of the disclosure. Further, detailed explanation of related known functions or constitutions will be omitted if they may obscure the gist of the disclosure. In the following description, it is to be noted that only portions required to understand the operations according to various embodiments of the disclosure will be described, but the description of other portions will be omitted not to obscure the gist of the disclosure. Further, in the disclosure, although various embodiments are described by using terms being used in some communication standards (e.g., 3rd Generation Partnership Project (3GPP)), they are merely exemplary for the description. Various embodiments of the disclosure may be easily modified and applied even to other communication systems. Various embodiments of the disclosure may be applied even in various steering modes, and are not limited only in a load-balancing mode.

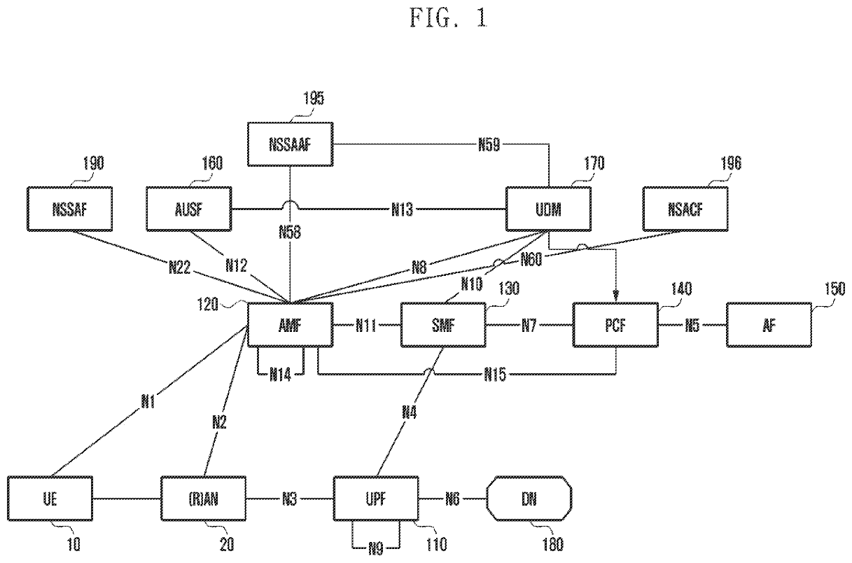

FIG. 1 is a diagram illustrating the structure of a 5G system according to an embodiment of the disclosure.

With reference to FIG. 1, the 5G system architecture may include various constituent elements (i.e., network function (NF)).

FIG. 1 exemplifies some of them corresponding to an authentication server function (AUSF) device 160, a (core) access and mobility management function (AMF) device 120, a session management function (SMF) device 130, a policy control function (PCF) device 140, an application function (AF) device 150, a unified data management (UDM) device 170, a data network (DN) 180, a user plane function (UPF) device 110, a (radio) access network ((R)AN) 20, and a terminal (i.e., user equipment (UE)) 10. Further, FIG. 1 exemplifies a network slice selection function (NSSF) device 190, a network slice specific authentication and authorization function (NSSAAF) device 195, and a network slice admission control function (NSACF) device 196.

The respective devices exemplified in FIG. 1 may be implemented by one server or device, or may be implemented by a network slice instance. In case of being implemented by the network slice instance, two or more identical or different network slice instances may be implemented in one server or device, or one network slice instance may be implemented in two or more servers or devices. Further, in the following description, the respective network function (NF) devices may be referred to as NF. For example, the UPF device may be referred to as UPF, and the PCF device may be referred to as PCF.

Each NF exemplified in FIG. 1 may support the following functions.

The AUSF 160 may process and store data for UE authentication.

The AMF 120 may provide a function for access and mobility management in the unit of a UE, and may be basically connected to one AMF per UE. Specifically, the AMF 120 may support functions of signaling between CN nodes for mobility between 3GPP access networks, termination of a radio access network (RAN) CP interface (i.e., N2 interface), NAS signaling termination (N1), NAS signaling security (NAS ciphering and integrity protection), AS security control, registration management (registration area management), connection management, idle mode UE reachability (including paging retransmission control and performance), mobility management control (subscription and policy), intra-system mobility and inter-system mobility support, network slicing support, SMF selection, lawful intercept (for AMF event and interface to L1 system), transfer and providing of session management (SM) message between UE 10 and SMF 130, transparent proxy for SM message routing, access authentication, access authorization including roaming rights, transfer and providing of SMS message between UE and short message service function (SMSF) (not illustrated in FIG. 1), security anchor function (SAF), and/or security context management (SCM). Some or all functions of the AMF 120 may be supported in a single AMF instance that operates as one AMF.

The DN 180 may mean, for example, an operator service, Internet access, or 3rd party service. The DN 180 may transmit a downlink protocol data unit (PDU) to the UPF 110, or may receive the PDU transmitted from the UE 10 through the UPF 110.

The PCF 140 may receive information about a packet flow from the application server, and may provide a policy determination function, such as mobility management and session management. Specifically, the PCF 140 may support functions of unified policy framework support for controlling a network operation, policy rules providing so that control plane function(s) (e.g., AMF, SMF, and so on) enforce the policy rules, and front end implementation for accessing related subscription information for policy decision in user data repository (UDR) (not illustrated in FIG. 1).

The SMF 130 may provide a session management function, and in case that the UE 10 has a plurality of sessions, the SMF 130 may be managed by different SMFs for each session. Specifically, the SMF 130 may support functions of session management (e.g., session establishment, correction, and termination including tunnel maintenance between UPF and AN node), UE IP address allocation and management (selectively including authentication), UP function selection and control, traffic steering settings for UPF 110 to route traffics to appropriate destination, interface termination toward policy control functions, policy and quality of service (QOS) control part enforcement, lawful intercept (for SM event and interface to L1 system), SM part termination of NAS message, downlink data notification, initiator of AN-specific SM information (transferred to AN through N2 via AMF), session SSC mode determination, and roaming. As described above, some or all functions of the SMF 130 may be supported within the single SMF instance that operates as one SMF.

The UDM 170 may store user's subscription data, policy data, and so on. The UDM 170 may include two parts, that is, application front end (FE) (not illustrated) and user data repository (UDR) (not illustrated).

The FE may include UDM FE in charge of location management, subscription management, and credentials processing, and PCF-FE in charge of policy control. The UDR may store data required for functions being provided by the UDM-FE and policy profiles required by the PCF. Data stored in the UDR may include subscription identifiers, security credentials, user subscription data including access and mobility related subscription data and session related subscription data, and policy data. The UDM-FE may access subscription information stored in the UDR, and may support functions of authentication credentials processing, user identification handling, access authentication, registration/mobility management, subscription management, and SMS management.

The UPF 110 may transfer downlink PDU received from the DN 180 to the UE 10 via the (R)AN 20, and may transfer uplink PDU received from the UE 10 to the DN 180 via the (R)AN 20. Specifically, the UPF 110 may support an anchor point for intra/inter-RAT mobility, external PDU session point of interconnect to data network 180, packet routing and forwarding, user plane part of packet inspection and policy rule enforcement, lawful intercept, traffic usage reporting, uplink classifier for supporting routing of a traffic flow to a data network, branching point for supporting multi-homed PDU session, QoS handling for a user plane (e.g., packet filtering, gating, and uplink/downlink rate enforcement), uplink traffic verification (SDF mapping between a service data flow (SDF) and a QoS flow), transport level packet marking in uplink and downlink, and downlink packet buffering and downlink data notification triggering functions. Some or all functions of the UPF 110 may be supported within a single UFP instance that operates as one UPF.

The AF 150 may interwork with the 3GPP core network for service providing (e.g., support of functions of application influence on traffic routing, access to network capability exposure, interwork with a policy framework for policy control). The (R)AN 20 may collectively refer to a new radio access network which supports all of an evolved E-UTRA that is an evolved version of the 4G radio access technology and a new radio access technology (new radio (NR)) (e.g., gNB). The gNB may support functions for radio resource management (i.e., radio bearer control, radio admission control, connection mobility control, dynamic allocation of resources to UE in uplink/downlink (i.e., scheduling), Internet protocol (IP) header compression, encryption and integrity protection of user data stream, selection of AMF 120 during attachment of UE 10 in case that routing to AMF 120 is not determined from information provided to UE 10, user plane data routing to UPF(s) 110, control plane information routing to AMF 120, connection setup and termination, scheduling and transmission (generated from AMF) of paging message, scheduling and transmission of system broadcast information (generated from AMF or operating and maintenance (O&M)), measurement for mobility and scheduling and measurement report setup, transport level packet marking in uplink, session management, network slicing support, QoS flow management and mapping to data radio bearer, support of UE 10 in inactive mode, NAS message distribution function, NAS node selection function, radio access network sharing, dual connectivity, and tight interworking between NR and E-UTRA.

The UE 10 may mean user equipment. The user equipment may be mentioned as a term of terminal, mobile equipment (ME), or mobile station (MS). Further, the user equipment may be a portable device, such as a notebook computer, cellular phone, personal digital assistant (PDA), smart phone, or multimedia device, or may be a non-portable device, such as a personal computer (PC) or vehicle-mount device. Hereinafter, explanation will be made by referring to user equipment (UE) or terminal.

Although a network exposure function (NEF) device and an NF repository function (NRF) device are not illustrated in FIG. 1 for clarity of explanation, all NFs to be described later may interwork with the NEF and NRF.

The NRF will now be described. The NRF (not illustrated in FIG. 1) may support a service discovery function. In case of receiving a second NF discovery request from a first NF instance, information on a second NF instance discovered after a second NF discovery operation is performed can be provided to the first NF instance. Further, available NF instances and services supported by them can be maintained.

On the other hand, although FIG. 1 exemplifies a reference model in case that UE 10 accesses one DN 180 by using one PDU session for convenience in explanation, the disclosure is not limited thereto.

The UE 10 may simultaneously access two (i.e., local and central) data networks by using multiple PDU sessions. In this case, two SMFs may be selected for different PDU sessions. However, each SMF may have capability to control all of local and central UPFs in the PDU session.

Further, the UE 10 may simultaneously access two (i.e., local and central) data networks being provided in a single PDU session.

The NSSF 190 performs selection of a set of network slice instances that support the UE, and performs judgment about allowed NSSAI that supports the UE, judgment about configured NSSAI, and judgment about AMF set. Further, the NSSF 190 may provide support of network slice restriction and network slice instance restriction based on analysis of the NWDAF.

The NSSAAF 195 may support network slice specific authentication and authorization by using an AAA server (AAA-S), and in case that the AAA-S belongs to a third party, the NSSAAF may contact the AAA-S through an AAA proxy (AAA-P). Further, the NSSAAF 195 may support to be able to access an SNPN by using credentials of a credentials holder by using the AAA server (AAA-S). In case that the credentials holder belongs to the third party, the NSSAAF 195 may connect to the AAA server through the AAA proxy (AAA-P).

The NSACF 196 may perform monitoring of the number of UEs registered per network slice and control support, monitoring of the number of PDU sessions set per network slice and control support, and/or event-based network slice state notification and report support for a consumer NF.

In the 3GPP system, a conceptual link that connects between NFs in the 5G system is defined as a reference point. Reference points included in the 5G system architecture expressed in FIG. 1 are exemplified as follows.
N1: Reference point between UE and AMF
N2: Reference point between (R)AN and AMF
N3: Reference point between (R)AN and UPF
N4: Reference point between SMF and UPF
N5: Reference point between PCF and AF
N6: Reference point between UPF and data network
N7: Reference point between SMF and PCF
N8: Reference point between UDM and AMF
N9: Reference point between two core UPFs
N10: Reference point between UDM and SMF
N11: Reference point between AMF and SMF
N12: Reference point between AMF and AUSF
N13: Reference point between UDM and authentication server function (AUSF)
N14: Reference point between two AMFs
N15: Reference point between PCF and AMF in case of non-roaming scenario, and reference point between PCF and AMF in visited network in case of roaming scenario
N22: reference point between AMF and NSSF
N58: Reference point between AMF and NSSAAF
N59: reference point between UDM and NSSAF
N80: reference point between AMF and NSAF

In the following description the terminal may mean the UE 10, and the terms “UE” and “terminal” may be interchangeably used. In this case, unless the terminal is specially defined additionally, it should be understood as the UE 10.

The UE may establish a session by accessing a data network (e.g., network that provides the Internet service) through the 5G system, and may distinguish respective data networks by using an identifier named data network name (DNN). In case that the UE connects the network system and the session to each other, the DNN may be used to determine the NF related to the user plane, interface between NFs, and service provider policy. For example, the DNN may be used to select the SMF 130 and UPF(s) 110 with respect to the PDU session, and may be used to select the interface(s) (e.g., N6 interface(s)) between the data network and the UPF 110 with respect to the PDU session. Further, the DNN may be used to determine a mobile communication service provider's policy for being applied to the PDU session.

The ATSSS function is a function of transferring data traffics through one or more accesses by utilizing all of the above-described 3GPP access and/or non-3GPP access between the UE and the 5G core network. As a representative example, in case that the 5G core network determines that the user-plane resources between the UE and the data network (DN) 160 are insufficient, or a load occurs in the resource management capacity of the network, the ATSSS function corresponds to a case that data is dispersed and transmitted by activating all of the 5G access and Wi-Fi access rather than transmitting the data traffic through only one of the 5G access or Wi-Fi access.

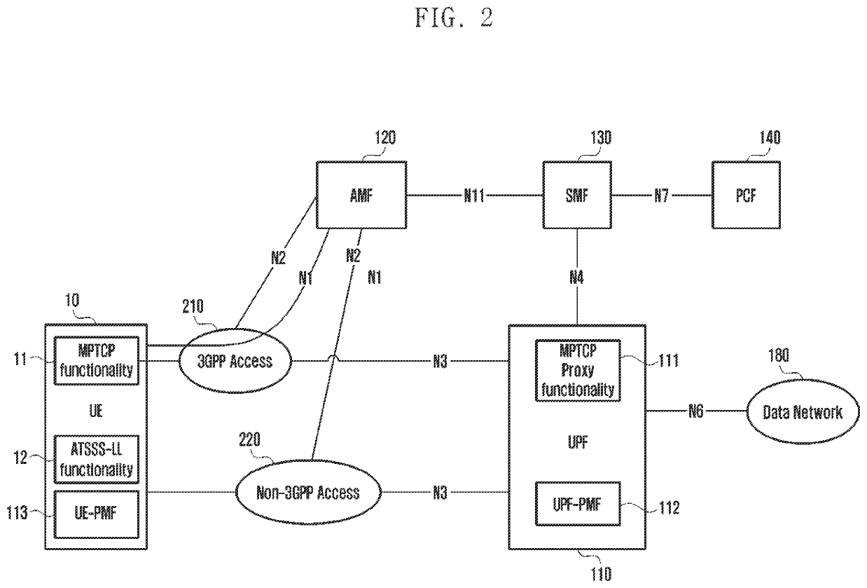

FIG. 2 is a diagram exemplifying an access traffic steering, switching, and splitting (ATSSS) support structure in a 3GPP 5G system.

With reference to FIG. 2, a UE 10 may access a mobile communication network, for example, 3GPP access 210, and a network that is not the mobile communication network, for example, non-3GPP access 220. Further, the UE 10 may communicate with an AMF 120 through the 3GPP access 210 and the non-3GPP access 220, and may transmit and receive data through a UPF 110.

In FIG. 2, the same reference numerals are used for the same constituent elements as the constituent elements described in FIG. 1. Accordingly, duplicate description of the same constituent elements will be omitted. FIG. 2 exemplifies a form in which ATSSS is supported by the UE 10 through the 3GPP access 210 and the non-3GPP access 220.

Hereinafter, the ATSSS function will be described. The ATSSS function is composed of a steering functionality and a steering mode. The steering functionality determines a transport protocol between the UPF 110 of a transmitting device and the UPF of a receiving device. The steering functionality is determined depending on what transport layer determines the steering, switching, and splitting of traffics, and in case of using a multi-path TCP (MPTCP) (IETF RFC 8684) protocol located on an upper layer than an IP layer, the steering functionality corresponds to “MPTCP functionality”, whereas in case of determination on a lower layer than the IP layer, the steering functionality corresponds to “ATSSS-LL (ATSSS-lower layer) functionality”. The UE 10 and the network supporting the MPTCP functionality may communicate with an MPTCP proxy 111 separately constituted in the UPF 110. The MPTCP functionality may control only the TCP traffics supporting the MPTCP protocol only. In case of supporting the ATSSS-LL functionality, the UPF 110 does not include a separate proxy constituent element, and may control all kinds of TCP traffics.

The steering mode defines a method for steering, switching, and splitting the data traffics.

Further, the UPF 110, SMF 130, and PCF 140 may perform a separate control operation for connection of the UE 10. Such a control operation will be further described with reference to the drawings to be described later.

As exemplified in the drawing, the UPF 110 according to the disclosure may include the MPTCP proxy function (proxy functionality) 111.

The performance measurement function (PMF) is a function of measuring a network environment between the UE 10 and the UPF 110, and may measure whether the round trip time (RTT) required for the uplink and downlink, 3GPP access 210, and non-3GPP access 220 are currently activated. The core network may determine the steering functionality and the steering mode supportable by the core network based on information provided by the PMF, and they have an overall influence on parameter determination for N3 and N4 connection. The PMF may be included in each of the UPF 110 and the UE 10. The PMF included in the UPF 110 may be referred to as a UPF-PMF 112, and the PMF included in the UE 10 may be referred to as a UE-PMF 113.

By utilizing the ATSSS function described with reference to FIG. 2, traffic transmission through multiple paths between the protocol data unit or packet data unit (PDU) session anchor UPF 110 and the UE 10 becomes possible as shown in FIG. 1.

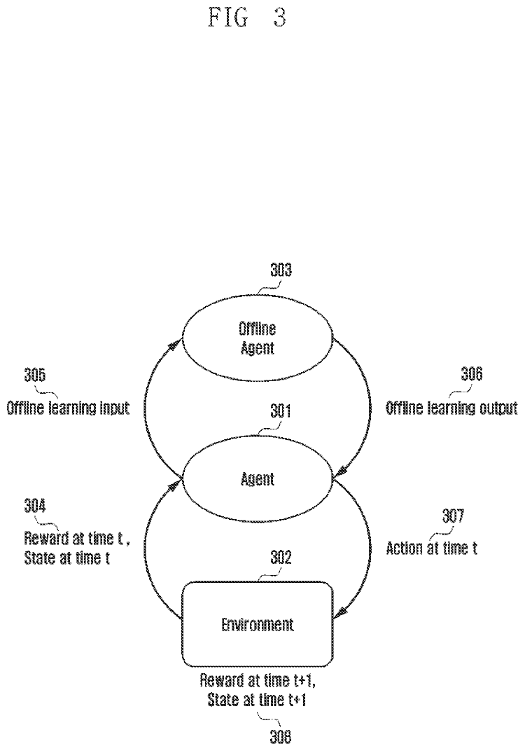

FIG. 3 is a diagram illustrating the structure of a deep reinforcement learning model related to an embodiment of the disclosure.

An agent 301 may become the subject that learns an action method in a direction in which the state of an environment 302 becomes the most successful state. The agent 301 may receive the current (time t) reward value and state value transferred from the environment 302. The agent 301 may determine the action in step 307 by using a deep neural network based on the reward and state values transferred from the environment 302. In accordance with the learning result of the agent 301, the weight factor and policy of the deep neural network that determines the optimum successful action may be determined. The agent 301 may perform learning by using a deep-Q network (DQN) that is a kind of deep neural network.

The environment 302 may determine the state value as in step 308 in accordance with the result of action in step 307, and may determine the reward value by comparing the previous state and the current state with each other. If the result of the current state (result in step 308) corresponds to a more successful state than the result of the previous state (result in step 304), a positive reward may be determined, whereas if the result of the current state (result in step 308) corresponds to a less successful state than the result of the previous state (result in step 304), a negative reward may be determined. In case that the result of the previous state (result in step 304) and the result of the current state (result in step 308) are the same, one of the positive reward, neutral reward, and negative reward may be determined.

An offline agent 303 may correspond to the subject that learns by using a deep neural network separately from the agent 301 with respect to all or part of the data that the agent 301 learns. As in step 305, an offline learning input may be all or part of the target data that the agent 301 learns or all or part of the weight factor or policy. As in step 306, the learning result of the offline agent 301 may be transferred to the agent 301 as an offline learning output. The agent 301 may update its own weight factor or policy based on the offline learning output.

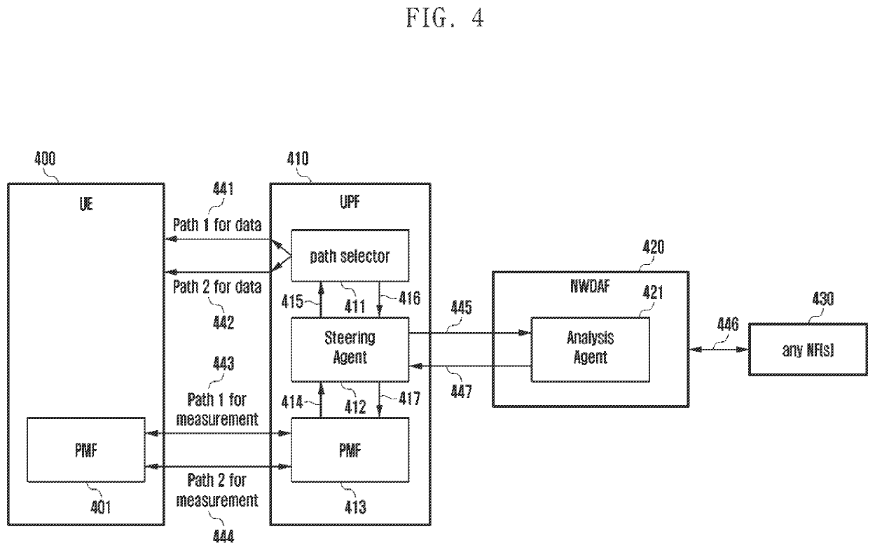

FIG. 4 is a diagram exemplifying the structure of a 5G system for providing ATSSS according to an embodiment of the disclosure.

First with reference to FIG. 4, different reference numerals are used for the same constituent elements described with reference to FIGS. 1 and 2. However, it is to be noted that basic operations and functions of the same constituent elements as described above with reference to FIGS. 1 and 2 may be included, and the reference numerals are changed to describe additional features according to the disclosure. FIG. 4 exemplifies UE 400, UPF 410, NWDAF 420, and NF(s) 430 in addition. The NF(s) 430 may be any NF exemplified in FIG. 1 and/or FIG. 2, and may be one NF or two or more NFs that can perform an operation associated with the operation according to the disclosure.

On the other hand, the UE 400 may include a PMF 401, and the PMF 401 may correspond to the UE-PMF 113 described above with reference to FIG. 2. Other operations excluding the contents as described above with reference to FIG. 2 will be described hereinafter.

The UPF 410 also includes a PMF 413, and the PMF 413 may correspond to the UPF-PMF 112 as described above with reference to FIG. 2. Other operations excluding the contents as described above with reference to FIG. 2 will be described hereinafter. Further, the UPF 410 may further include a steering agent 412 and a path selector 411.

Although not exemplified in FIGS. 1 and 2, the NWDAF 420 may be one NF constituting the 5G core network. The NWDAF 420 may support data collection in the NF and the AF, may support data collection in OAM, and may support NWDAF service registration and metadata exposure for the NF and the AF. Further, the NWDAF 420 may support analyzed information provisioning for the NF and the AF. An analysis agent 421 included in the NWDAF 420 may support NWDAF machine learning model training and NWDAF provisioning.

Hereinafter, with reference to FIG. 4, explanation will be made with focus on a process in which the UPF 410 determines a method for transmitting traffics to the UE 400 by using Path 1 441 and Path 2 442.

### [Data Traffic Transmission Method Learning Process of Steering Agent 412]

Hereinafter, specific values may be a specific example of information. For example, measurement information about a first path may include an RTT delay value, a congestion degree value, and a value indicating access availability. Further, such information may be collectively expressed as performance measurement values, and such performance measurement values may also be performance measurement information. Accordingly, all values mentioned in the disclosure may correspond to information or a part of the information.

In the first step, the UPF-PMF 413 may request the UE-PMF 401 to measure an access performance of path 1 (443), and may request the UE-PMF 401 to measure an access performance of path 2 (444). As targets of the access performance measurement, a round trip time (RTT) delay, congestion degree, and/or access availability may be included. In FIG. 4, path 1 and path 2 are not directly exemplified, and reference numerals 443 and 444 exemplify request information for each path and an operation of transmitting a response.

In the second step, the UE-PMF 401 may transmit, to the UPF-PMF 413, the access performance measurement value 443 of path 1 and the access performance measurement value 444 of path 2. In the description with reference to FIG. 4, a case in which the UE-PMF 401 receives the performance measurement request in the first step from the UPF-PMF 413 is assumed, but even if the performance measurement request is not received, the UE-PMF 401 may transmit the access performance measurement value to the UPF-PMF 413. A case in which the access performance measurement value is transmitted to the UPF-PMF 413 although the performance measurement request is not received may be based on predetermined appointments. For example, various appointments may exist, such as a specific time unit or detection of movement of the UE 400.

In the third step, the UPF-PMF 413 may provide the access performance measurement value received from the steering agent 412 in the second step and an evaluation value for increasing the quality of the data transmission service (414). Elements that determine the quality of the data transmission service may include throughput of path 1 and path 2, and network congestion. The UPF-PMF 413 may compare the access performance measurement value (state at time t) currently received from the UE-PMF 401 in the second step, the previously received access performance measurement value (state at time t−1), and the service quality required by the data transmission service being used by the UE 400 with each other, and may provide, to the steering agent 412, at least one (reward at time t) of a negative evaluation value, a neutral evaluation value, or a positive evaluation value (414). In the fourth step, the steering agent 412 may determine a method for transmitting data traffics to Path 1 and/or Path 2 (action at time t) through learning using the deep neural network based on the access performance measurement value and the evaluation value transferred from the UPF-PMF 413 like the reference numeral 414 in the previous third step. The steering agent 412 may perform learning in the direction in which the quality of the data transmission service described above in the second step is improved. The steering agent 412 may determine to transmit the total traffic amount that the UPF 410 should transmit to the UE 400 through division by a predetermined ratio (e.g., Path 1 20% and Path 2 80%, or Path 1 80% and Path 2 20%), may determine to transmit the data traffics through division of the paths in accordance with the required QoS values (e.g., Path 1 for 20 ms or more of the required packet delay budget, and Path 2 for less than 20 ms), or may determine the paths in accordance with the characteristics of the service quality determination elements. Such determination performed by the steering agent 412 in the fourth step may be determined based on the values (information) received in the third step and predetermined rules.

In the fifth step, the steering agent 412 may transmit the data traffic transmission method (action at t) determined in the previous fourth step to the path selector 411. In the sixth step, the path selector 411 may transmit the data traffics to the UE 400 through Path 1 and/or Path 2 like the reference numerals 441 and 442 in accordance with the method for transmitting the data traffics received in the previous fifth step. In the seventh step, the path selector 411 may provide an acknowledgment for the result in the previous sixth step to the steering agent 412 (416).

In the eighth step, the steering agent 412 may provide an acknowledgment for the result in the sixth step and the seventh step as previously described to the UPF-PMF 413 (417).

### [Data Traffic Transmission Method Learning Process of Analysis Agent 421]

In the first step, the steering agent 412 may provide all or a part (offline input) of data traffic transmission method learning data to the analysis agent 421 (445).

In the second step, the analysis agent 421 may learn the data traffic transmission method by using the deep neural network model based on the data (445) received from the steering agent 412.

In the third step, in learning the data traffic transmission method in the second step, the analysis agent 421 may perform learning in further consideration of network state information (446) collected by the NWDAF 420 from other network functions (e.g., AMF and PCF).

In the fourth step, the analysis agent 421 may provide (offline input) the learning result in the second step and/or the third step to the steering agent 412 (447).

In the fifth step, the steering agent 412 may update the deep neural network model based on the information (447) received from the analysis agent 421 in the fourth step. For example, the steering agent 412 may update the weight factor and policy of the deep neural network model.

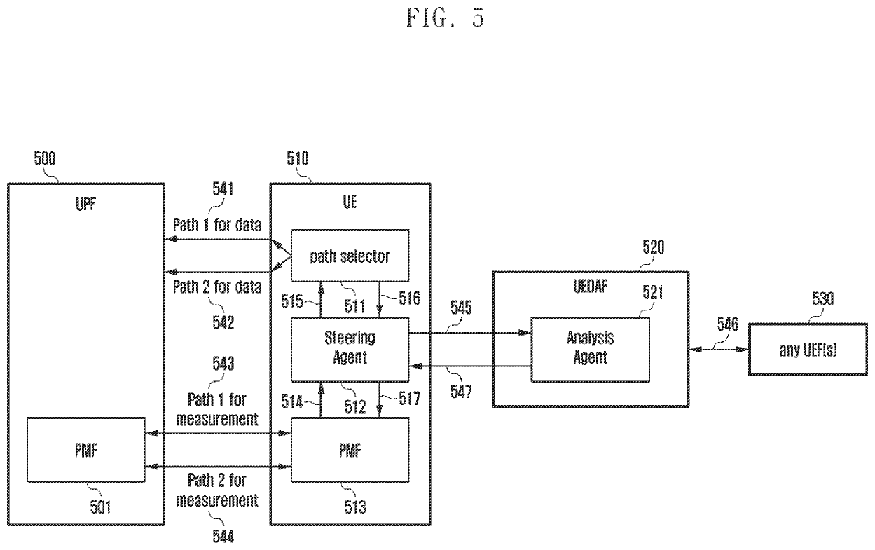

FIG. 5 is a diagram exemplifying the structure of a 5G system for performing ATSSS according to an embodiment of the disclosure.

First with reference to FIG. 5, in the same manner as in FIG. 4, different reference numerals are used for the same constituent elements described with reference to FIGS. 1 and 2. However, it is to be noted that basic operations and functions of the same constituent elements as described above with reference to FIGS. 1 and 2 may be included, and the reference numerals are changed to describe additional features according to the disclosure.

On the other hand, the UE 500 may include a PMF 501, and the PMF 501 may correspond to the UE-PMF 113 described above with reference to FIG. 2. Other operations excluding the contents as described above with reference to FIG. 2 will be described hereinafter.

Even in FIG. 5, the UPF 510 also includes a PMF 513, and the PMF 513 may correspond to the UPF-PMF 112 as described above with reference to FIG. 2. Other operations excluding the contents as described above with reference to FIG. 2 will be described hereinafter. Further, the UPF 510 may further include a steering agent 512 and a path selector 511.

In FIG. 5, the UE 500, UPF 510, UEDAF 520, and other UEF(s) 530 are exemplified.

The UE data analysis function (UEDAF) 520 may support analyzed information provisioning for the UEF. An analysis agent 521 included in the UEDAF 520 may support machine learning model training for NWDAF and NWDAF provisioning. The UE equipment function (UEF) 530 may correspond to a module constituting the UE, and may include modules required for the UE to perform communication, such as an application, an operating system, a modem, and a battery.

In FIG. 5, explanation will be made with focus on a process in which the UE 510 determines a method for transmitting traffics to the UPF 500 by using Path 1 541 and Path 2 542.

### [Data Traffic Transmission Method Learning Process of Steering Agent 512]

Hereinafter, specific values may be a specific example of information. For example, measurement information about a first path may include an RTT delay value, a congestion degree value, and a value indicating access availability. Further, such information may be collectively expressed as performance measurement values, and such performance measurement values may also be performance measurement information. Accordingly, all values mentioned in the disclosure may correspond to information or a part of the information.

In the first step, the UE-PMF 503 may request the UPF-PMF 513 to measure an access performance of path 1 (543), and may request the UE-PMF 401 to measure an access performance of path 2 (544). As targets of the access performance measurement, a round trip time (RTT) delay, congestion degree, and/or access availability may be included. In FIG. 5, path 1 and path 2 are not directly exemplified, and reference numerals 543 and 544 exemplify an operation of transmitting request information for each path.

In the second step, the UPF-PMF 501 may transmit, to the UE-PMF 513, the access performance measurement value 543 of path 1 and the access performance measurement value 544 of path 2. In the description with reference to FIG. 5, a case in which the UPF-PMF 501 receives the performance measurement request in the first step from the UE-PMF 513 is assumed, but even if the performance measurement request is not received, the UPF-PMF 501 may transmit the access performance measurement value to the UE-PMF 513. A case in which the access performance measurement value is transmitted to the UE-PMF 513 although the performance measurement request is not received may be based on predetermined appointments. For example, various appointments may exist, in case that specific time unit and changes of UPF policy or congestion degree are detected.

In the third step, the UE-PMF 513 may provide the access performance measurement value received from the steering agent 512 in the second step and an evaluation value for increasing the quality of the data transmission service (514). Elements that determine the quality of the data transmission service may include throughput of path 1 and path 2, and network congestion. The UE-PMF 513 may compare the access performance measurement value (state at time t) currently received from the UPF-PMF 501 in the second step, the previously received access performance measurement value (state at time t−1), and the service quality required by the data transmission service being used by the UE 400 with each other, and may provide, to the steering agent 512, at least one (reward at time t) of a negative evaluation value, a neutral evaluation value, or a positive evaluation value (514). In the fourth step, the steering agent 512 may determine a method for transmitting data traffics to Path 1 and/or Path 2 (action at time t) through learning using the deep neural network based on the access performance measurement value and the evaluation value transferred from the UE-PMF 513 like the reference numeral 514 in the previous third step. The steering agent 512 may perform learning in the direction in which the quality of the data transmission service described above in the second step is improved. The steering agent 512 may determine to transmit the total traffic amount that the UE 510 should transmit to the UPF 500 through division by a predetermined ratio (e.g., Path 1 20% and Path 2 80%, or Path 1 80% and Path 2 20%), may determine to transmit the data traffics through division of the paths in accordance with the required QoS values (e.g., Path 1 for 20 ms or more of the required packet delay budget, and Path 2 for less than 20 ms), or may determine the paths in accordance with the characteristics of the service quality determination elements. Such determination performed by the steering agent 512 in the fourth step may be determined based on the values (information) received in the third step and predetermined rules.

In the fifth step, the steering agent 512 may transmit the data traffic transmission method (action at t) determined in the previous fourth step to the path selector 511. In the sixth step, the path selector 511 may transmit the data traffics to the UPF 500 through Path 1 and/or Path 2 like the reference numerals 541 and 542 in accordance with the method for transmitting the data traffics received in the previous fifth step. In the seventh step, the path selector 511 may provide an acknowledgment for the result in the previous sixth step to the steering agent 512 (516).

In the eighth step, the steering agent 512 may provide an acknowledgment for the result in the sixth step and the seventh step as previously described to the UE-PMF 513 (517).

### [Data Traffic Transmission Method Learning Process of Analysis Agent 521]

In the first step, the steering agent 512 may provide all or a part (offline input) of data traffic transmission method learning data to the analysis agent 521 (545).

In the second step, the analysis agent 521 may learn the data traffic transmission method by using the deep neural network model based on the data (545) received from the steering agent 512.

In the third step, in learning the data traffic transmission method in the second step, the analysis agent 521 may perform learning in further consideration of UE state information (546) collected by the UEDAF 520 from other UE functions (e.g., application, operating system, modem, and battery).

In the fourth step, the analysis agent 521 may provide (offline input) the learning result in the second step and/or the third step to the steering agent 512 (547).

In the fifth step, the steering agent 512 may update the deep neural network model based on the information (547) received from the analysis agent 521 in the fourth step. For example, the steering agent 512 may update the weight factor and policy of the deep neural network model.

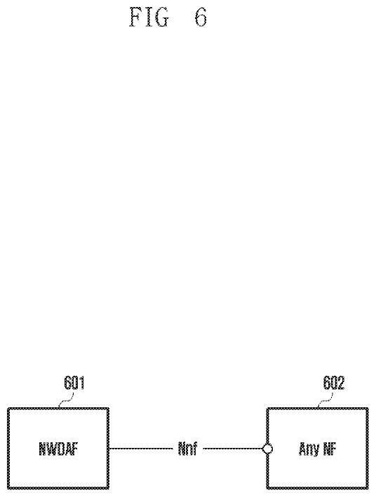

FIG. 6 is a diagram exemplifying a connection between NWDAF for providing ATSSS and another NF according to an embodiment of the disclosure.

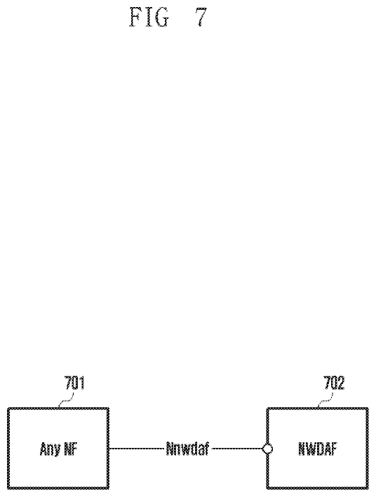

FIG. 6 exemplifies a network data analytics function (NWDAF) device 601. The NWDAF may collect data from a certain NF included in the core network. In this case, the NWDAF 601 and an opposite NF 602 should belong to the same PLMN. Between the NWDAF 601 and a certain NF, an Nnf reference point may be used. FIG. 7 is a diagram exemplifying a connection between NWDAF for providing ATSSS and another NF according to an embodiment of the disclosure.

FIG. 7 exemplifies a network data analytics function (NWDAF) device 702. A certain NF included in the core network may request network analysis information and an analytics logical function (AnLF) from the NWDAF 702. Between the request NF (consumer NF) and the NWDAF, an Nnwdaf reference point may be used. The request NF and the NWDAF that consume the analysis information should belong to the same PLMN.

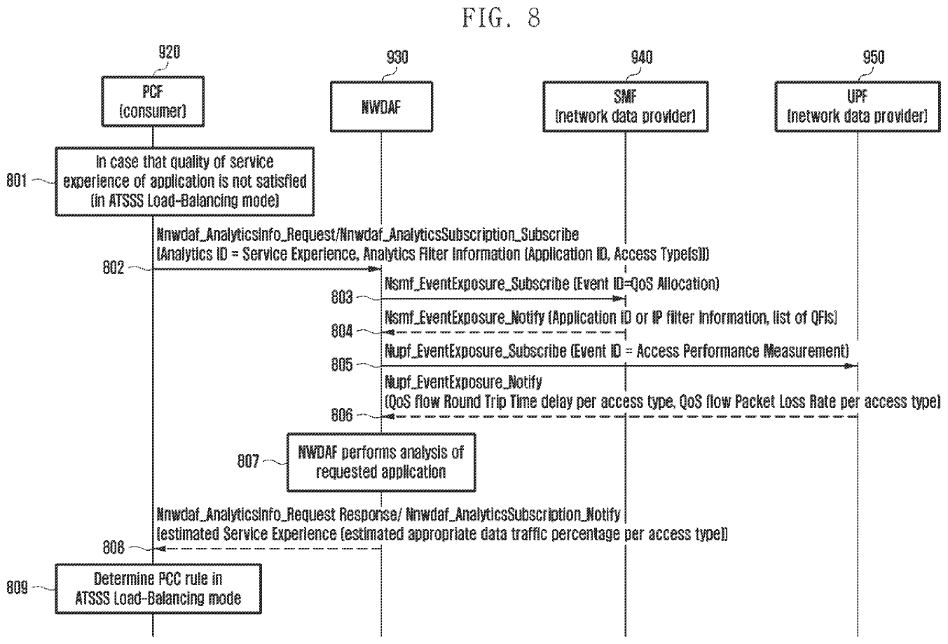

FIG. 8 is a diagram illustrating a first embodiment in which an entity that performs a policy control function (PCF) by using a network data analysis performs a policy control and charging (PCC) rules determination procedure.

First with reference to FIG. 8, different reference numerals are used for the same constituent elements described with reference to FIGS. 1 and 2. However, it is to be noted that basic operations and functions of the same constituent elements as described above with reference to FIGS. 1 and 2 may be included, and the reference numerals are changed to describe additional features according to the disclosure. Further, the disclosure may be applied even to different steering modes, but is not limited to a load-balancing mode.

In step 801, a PCF may recognize necessity of policy control and charging rules determination. Specifically, the PCF 820 may determine that the quality required by the quality of service experience of an application is not satisfied in an MA PDU session using an ATSSS load-balancing mode. For example, using the ATSSS load-balancing mode, application data may be transmitted in the ratio of 3GPP access path X % and non-3GPP access path Y %. In case that the service quality level promised by an application service provider and a core network operator is not satisfied in at least one of the above-described access paths, the PCF may re-determine the parameter of the ATSSS load-balancing mode by using the network analysis function. As an index of the service quality level, a mean opinion score (MOS) may be used.

In step 802, the PCF 820 may request the network data analysis for the quality of service experience of an application from NWDAF 830. The PCF may request the analysis of the quality of service experience for each access type.

The request may include an analytics identifier (ID) and analytics filter information. The value of the analytics ID may include a service experience. The analytics filter information may include an application identifier (ID) and access type(s). The access type may include a 3GPP access type and/or non-3GPP access type. The request in step 802 may be transferred through an Analytics Info Request or Analytics Subscription Subscribe message.

The NWDAF 830 may measure the quality of service experience for each QoS profile being used for application data transmission. The NWDAF 830 may collect network data obtained through measurement of the quality of service experience from SMF 840, UPF 850, and AF.

The operations in steps 805 and 806 may be performed by the AF instead of the UPF 850. In case that the UPF 850 performs the operation, the NWDAF 830 may collect the access performance measurement result for downlink data of the application data, that is, the data being transmitted from the UPF to the UE. In case that the AF performs the operation, the NWDAF 830 may collect the access performance measurement result for uplink data of the application data, that is, the data being transmitted from the UE to the AF. In case that the NWDAF 830 collects the network data from the AF, steps 805 and 806 may be performed through the NEF between the NWDAF 830 and the AF.

In step 803, the NWDAF 830 may request the SMF 840 to provide the network data related to a QoS flow allocated to the application. This request may include an event ID, and the value of the event ID may be QoS Allocation. This request may be transferred through an event exposure subscribe message.

In step 804, the SMF 840 may notify the NWDAF 830 of a list of QoS flow identifiers (QFI) being used to transmit the application data. This notification may be transferred through an event exposure notify message.

In step 805, the NWDAF 830 may request the UPF 850 to provide the network data related to the access performance measurement of the application data. This request may include an event ID, and the value of the event ID may be the access performance measurement. This request may be transferred through an event exposure subscribe message.

In step 806, the UPF 850 may notify the NWDAF 830 of the transmission performance measurement result for each access of the application data. The UPF may measure the QoS flow bit rate and/or packet delay for each access type through the PMF.

For example, the PMF of the UPF 850 may measure an RTT delay with respect to one or more QoS flows being applied to the 3GPP access path, and an RTT delay with respect to one or more QoS flows being applied to the non-3GPP access path, and may notify the NWDAF 830 of the measured values. As another example, the PMF of the UPF 850 may measure a packet loss rate with respect to one or more QoS flows being applied to the 3GPP access path, and a packet loss rate with respect to one or more QoS flows being applied to the non-3GPP access path, and may notify the NWDAF of the measured values. This notification may be transferred through an event exposure notify message.

The NWDAF 830 may perform analysis of the application based on the network data collected in steps 803 to 806. In this analysis, the deep reinforcement learning model as described above with reference to FIG. 3 may be applied.

In step 808, the NWDAF 830 may provide the network data analysis result for the quality of service experience of the application to the PCF 820. In this case, the analysis result may be the analysis result for an appropriate data traffic ratio for each access type, and may be the estimated result that means it is appropriate to transmit the application traffic in the ratio of 3GPP access type Z % and non-3GPP access type W % for a predetermined time. The notification in step 808 may be transferred through an Analytics Info Response or Analytics Subscription Notify message.

In step 809, the PCF 820 may determine the policy control and charging rules for the ATSSS load-balancing mode to be applied to the application data transmission based on the received analysis result. For example, in case that the estimation result, which means that it will be appropriate to transmit the application traffic in the ratio of 3GPP access type Z % and non-3GPP access type W % for a predetermined time, is received, the ATSSS load-balancing mode attribute value can be set in the ratio of 3GPP access type Z % and non-3GPP access type W % as MA PDU session control information.

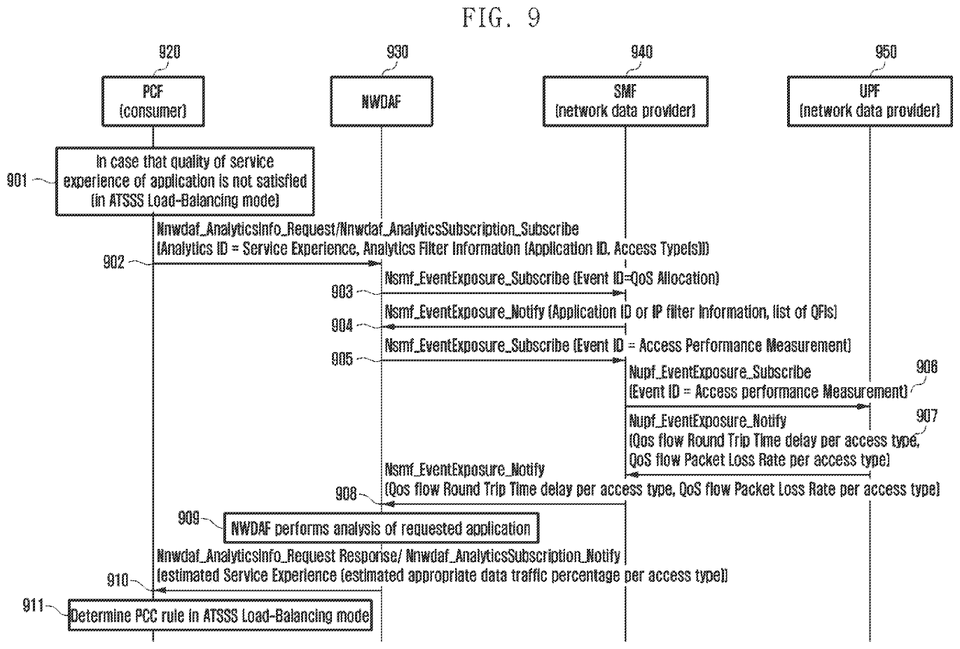

FIG. 9 is a diagram illustrating a second embodiment in which an entity that performs a policy control function (PCF) by using a network data analysis performs a policy control and charging (PCC) rules determination procedure.

First with reference to FIG. 9, different reference numerals are used for the same constituent elements described with reference to FIGS. 1 and 2. However, it is to be noted that basic operations and functions of the same constituent elements as described above with reference to FIGS. 1 and 2 may be included, and the reference numerals are changed to describe additional features according to the disclosure. Further, the disclosure may be applied even to different steering modes, but is not limited to a load-balancing mode.

In step 901, a PCF 920 may recognize necessity of policy control and charging rules determination. Specifically, the PCF 920 may determine that the quality required by the quality of service experience of an application is not satisfied in an MA PDU session using an ATSSS load-balancing mode. For example, using the ATSSS load-balancing mode, application data may be transmitted in the ratio of 3GPP access path X % and non-3GPP access path Y %. In case that the service quality level promised by an application service provider and a core network operator is not satisfied in at least one of the above-described access paths, the PCF 920 may re-determine the parameter of the ATSSS load-balancing mode by using the network analysis function (930). As an index of the service quality level, a mean opinion score (MOS) may be used.

In step 902, the PCF 920 may request the network data analysis for the quality of service experience of an application from NWDAF 930. The PCF 920 may request the analysis of the quality of service experience for each access type.

The request may include an analytics identifier (ID) and analytics filter information. The value of the analytics ID may include a service experience. The analytics filter information may include an application identifier (ID) and access type(s). The access type may include a 3GPP access type and/or non-3GPP access type. The request in step 902 may be transferred through an Analytics Info Request or Analytics Subscription Subscribe message.

The NWDAF 930 may measure the quality of service experience for each QoS profile being used for application data transmission. The NWDAF 930 may collect network data obtained through measurement of the quality of service experience from SMF 940, UPF 950, and AF.

The operations in steps 905 and 908 may be performed by the AF instead of the UPF 950. In case that the UPF 950 performs the operation, the NWDAF 930 may collect the access performance measurement result for downlink data of the application data, that is, the data being transmitted from the UPF 950 to the UE. In case that the AF performs the operation, the NWDAF 930 may collect the access performance measurement result for uplink data of the application data, that is, the data being transmitted from the UE to the AF. In case that the NWDAF 930 collects the network data from the AF, steps 905 and 908 may be performed through the NEF between the NWDAF 930 and the AF.

In step 903, the NWDAF 930 may request the SMF 940 to provide the network data related to a QoS flow allocated to the application. This request may include an event ID, and the value of the event ID may include QoS Allocation. The request may be transferred through an event exposure subscribe message.

In step 904, the SMF 940 may notify the NWDAF 930 of a list of QoS flow identifiers (QFI) being used to transmit the application data. This notification may be transferred through an event exposure notify message.

The NWDAF 930 may request information from the UPF 950 through the SMF 940.

First, a case that the NWDAF 930 determines to request the information from the UPF 950 through the SMF 940 may be as follows. In step 902, a case that the UPF managing the user plane of the MA PDU session that becomes the target of the PCF request is unable to be determined may be included. Further, in step 902, a case that there are one or more UPFs managing the user plane of the MA PDU session that becomes the target of the PCF request may be included.

In step 905, in case that the NWDAF 930 determines to request the information from the UPF 950 through the SMF 940, the NWDAF 930 may request the SMF 940 to provide the network data related to the access performance measurement of the application data. The request may include the event ID, and the event ID value may include the access performance measurement. The request may be transferred through the event exposure subscribe message. Further, the request may be separately transmitted, but the embodiment of the disclosure is not limited thereto. The SMF 940 having received the network data providing request related to the data access performance measurement may select the UPF for the MA PDU session that becomes the target of data collection requested by the NWDAF 930.

In step 906, the SMF 940 may request the UPF 950 to provide (or transfer) the network data related to the data access performance measurement. The request may be transferred through the event exposure subscribe message.

The UPF 950 may measure the bit rate and/or packet delay of the QoS flow for each access type through the PMF. For example, the PMF of the UPF 950 may measure the RTT delay with respect to one or more QoS flows being applied to the 3GPP access path, and may measure the RTT delay with respect to one or more QoS flows being applied to the non-3GPP access path. Thereafter, the measured values may be notified the NWDAF 930. As another example, the PMF of the UPF 950 may measure the packet loss rate with respect to one or more QoS flows being applied to the 3GPP access path, and may measure the packet loss rate with respect to one or more QoS flows being applied to the non-3GPP access path.

The UPF 950 may provide the measurement result to the NWDAF 930 through the SMF 940. In step 907, the UPF 950 may transmit the transmission performance measurement result for each access of the application data. The transmission may be transferred through the event exposure notify message.

Thereafter, in step 908, the SMF 940 may transmit (or transfer) the transmission performance measurement result for each access of the application data to the NWDAF 930. The transmission may be transferred through the event exposure notify message.

In step 909, the NWDAF 930 may perform analysis of the application based on the network data collected in steps 905 to 908. In this analysis, the deep reinforcement learning model as described above with reference to FIG. 3 may be applied.

In step 910, the NWDAF 930 may provide the network data analysis result for the quality of service experience of the application to the PCF 920. In this case, the analysis result may be the analysis result for an appropriate data traffic ratio for each access type, and may be the estimated result that means it is appropriate to transmit the application traffic in the ratio of 3GPP access type Z % and non-3GPP access type W % for a predetermined time. The notification in step 910 may be transferred through an Analytics Info Response or Analytics Subscription Notify message.

In step 911, the PCF 920 may determine the policy control and charging rules for the ATSSS load-balancing mode to be applied to the application data transmission based on the received analysis result. For example, in case that the estimation result, which means that it will be appropriate to transmit the application traffic in the ratio of 3GPP access type Z % and non-3GPP access type W % for a predetermined time, is received, the ATSSS load-balancing mode attribute value can be set in the ratio of 3GPP access type Z % and non-3GPP access type W % as MA PDU session control information.

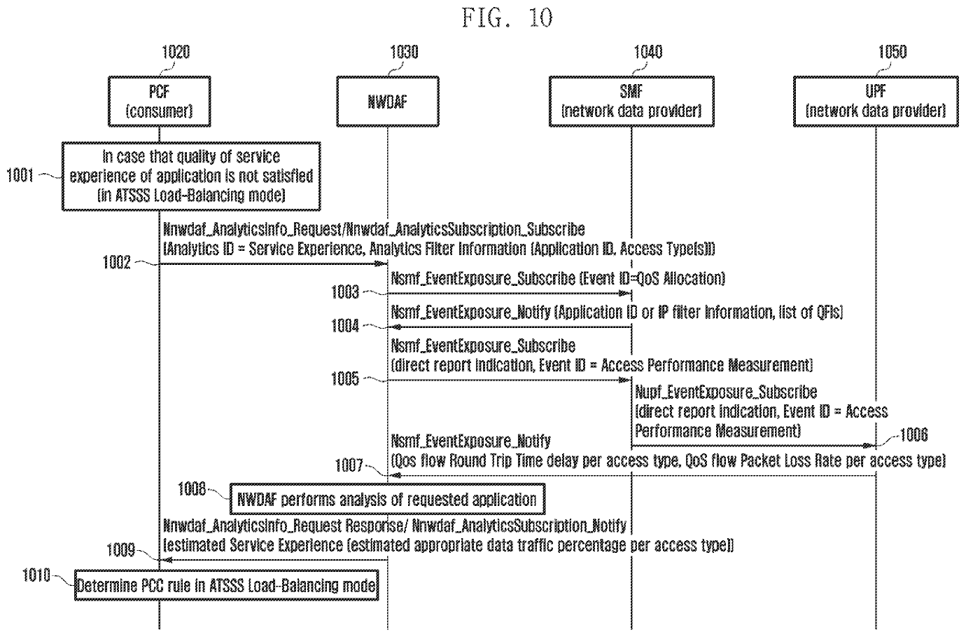

FIG. 10 is a diagram illustrating a third embodiment in which an entity that performs a policy control function (PCF) by using a network data analysis performs a policy control and charging (PCC) rule determination procedure.

First with reference to FIG. 10, different reference numerals are used for the same constituent elements described with reference to FIGS. 1 and 2. However, it is to be noted that basic operations and functions of the same constituent elements as described above with reference to FIGS. 1 and 2 may be included, and the reference numerals are changed to describe additional features according to the disclosure. Further, the disclosure may be applied even to different steering modes, but is not limited to a load-balancing mode.

In step 1001, a PCF 1020 may recognize necessity of policy control and charging rules determination. Specifically, the PCF 1020 may determine that the quality required by the quality of service experience of an application is not satisfied in an MA PDU session using an ATSSS load-balancing mode. For example, using the ATSSS load-balancing mode, application data may be transmitted in the ratio of 3GPP access path X % and non-3GPP access path Y %. In case that the service quality level promised by an application service provider and a core network operator is not satisfied in at least one of the above-described access paths, the PCF 1020 may re-determine the parameter of the ATSSS load-balancing mode by using the network analysis function (1030). As an index of the service quality level, a mean opinion score (MOS) may be used.

In step 1002, the PCF 1020 may request the network data analysis for the quality of service experience of an application from NWDAF 1030. The PCF 1020 may request the analysis of the quality of service experience for each access type.

The request may include an analytics identifier (ID) and analytics filter information. The value of the analytics ID may include a service experience. The analytics filter information may include an application identifier (ID) and access type(s). The access type may include a 3GPP access type and/or non-3GPP access type. The request in step 1002 may be transferred through an Analytics Info Request or Analytics Subscription Subscribe message.

The NWDAF 1030 may measure the quality of service experience for each QoS profile being used for application data transmission. The NWDAF 1030 may collect network data obtained through measurement of the quality of service experience from SMF 1040, UPF 1050, and AF.

The operations in steps 1005 to 1007 may be performed by the AF instead of the UPF 1050. In case that the UPF 1050 performs the operation, the NWDAF 1030 may collect the access performance measurement result for downlink data of the application data, that is, the data being transmitted from the UPF 1050 to the UE. In case that the AF performs the operation, the NWDAF 1030 may collect the access performance measurement result for uplink data of the application data, that is, the data being transmitted from the UE to the AF. In case that the NWDAF 1030 collects the network data from the AF, steps 1005 to 1007 may be performed through the NEF between the NWDAF 1030 and the AF.

In step 1003, the NWDAF 1030 may request the SMF 1040 to provide the network data related to a QoS flow allocated to the application. This request may include an event ID, and the value of the event ID may include QoS Allocation. The request may be transferred through an event exposure subscribe message.

In step 1004, the SMF 1040 may notify the NWDAF 1030 of a list of QoS flow identifiers (QFI) being used to transmit the application data. This notification may be transferred through an event exposure notify message.

The NWDAF 1030 may request information from the UPF 1050 through the SMF 1040. First, a case that the NWDAF 1030 determines to request the information from the UPF 1050 through the SMF 1040 may be as follows. In step 1002, a case that the UPF managing the user plane of the MA PDU session that becomes the target of the PCF request is unable to be determined may be included. Further, in step 1002, a case that there are one or more UPFs managing the user plane of the MA PDU session that becomes the target of the PCF request may be included. In step 1005, in case that the NWDAF 1030 determines to request the information from the UPF 1050 through the SMF 1040, the NWDAF 1030 may request the SMF 1040 to provide the network data related to the access performance measurement of the application data. The request may include the event ID, and the event ID value may include the access performance measurement. The request may be transferred through the event exposure subscribe message. Further, the request may be separately transmitted, but the embodiment of the disclosure is not limited thereto.

When the NWDAF 1030 requests the SMF 1040 to provide the network data related to the access performance measurement of the application data, the NWDAF 1030 may provide information about an indicator (hereinafter, for convenience, direct report indication) for requesting the UPF 1050 to directly provide the network data to the NWDAF 1030.

The SMF 1040 having received the network data providing request related to the data access performance measurement may select the UPF for the MA PDU session that becomes the target of data collection requested by the NWDAF 1030.

In step 1006, the SMF 1040 may request the UPF 950 to provide (or transfer) the network data related to the data access performance measurement. The request may be transferred through the event exposure subscribe message. Further, in case of receiving the information about the direct report indication from the NWDAF 1030, the SMF 1040 may transfer the information about the direct report indication to the UPF. Even if the SMF 1040 has not received the direct report indication from the NWDAF 1030, the SMF 1040 may provide the direct report indication to the UPF 1050 in accordance with determination of the SMF and/or another NF, or another network entity.

The UPF 1050 may measure the bit rate and/or packet delay of the QoS flow for each access type through the PMF. For example, the PMF of the UPF 1050 may measure the RTT delay with respect to one or more QoS flows being applied to the 3GPP access path, and may measure the RTT delay with respect to one or more QoS flows being applied to the non-3GPP access path. Thereafter, the measured values may be notified the NWDAF 1030. As another example, the PMF of the UPF 1050 may measure the packet loss rate with respect to one or more QoS flows being applied to the 3GPP access path, and may measure the packet loss rate with respect to one or more QoS flows being applied to the non-3GPP access path. In step 1007, the UPF 1050 may directly provide the measurement result to the NWDAF 1030. The measurement result may include the transmission performance measurement result for each access of the application data. The case that the UPF 1050 determines to directly provide the measurement result to the NWDAF 1030 may include a case that the UPF 1050 receives the direct report indication, or the direct report indication is determined based on the determination of the SMF and/or another NF, or another network entity. The transmission of the measurement result may be transferred through the event exposure notify message.

In step 1008, the NWDAF 1030 may perform analysis of the application based on the network data collected in steps 1005 to 1007. In this analysis, the deep reinforcement learning model as described above with reference to FIG. 3 may be applied.

In step 1009, the NWDAF 1030 may provide the network data analysis result for the quality of service experience of the application to the PCF 1020. In this case, the analysis result may be the analysis result for an appropriate data traffic ratio for each access type, and may be the estimated result that means it is appropriate to transmit the application traffic in the ratio of 3GPP access type Z % and non-3GPP access type W % for a predetermined time. The notification in step 1009 may be transferred through an Analytics Info Response or Analytics Subscription Notify message.

In step 1010, the PCF 1020 may determine the policy control and charging rules for the ATSSS load-balancing mode to be applied to the application data transmission based on the received analysis result. For example, in case that the estimation result, which means that it will be appropriate to transmit the application traffic in the ratio of 3GPP access type Z % and non-3GPP access type W % for a predetermined time, is received, the ATSSS load-balancing mode attribute value can be set in the ratio of 3GPP access type Z % and non-3GPP access type W % as MA PDU session control information.

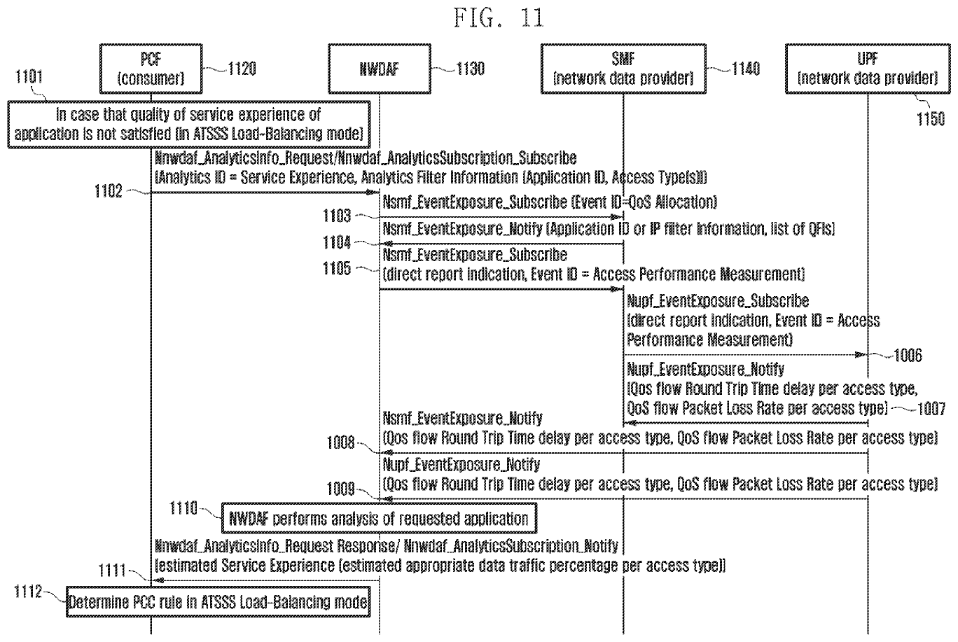

FIG. 11 is a diagram illustrating a fourth embodiment in which an entity that performs a policy control function (PCF) by using a network data analysis performs a policy control and charging (PCC) rule determination procedure.

First with reference to FIG. 11, different reference numerals are used for the same constituent elements described with reference to FIGS. 1 and 2. However, it is to be noted that basic operations and functions of the same constituent elements as described above with reference to FIGS. 1 and 2 may be included, and the reference numerals are changed to describe additional features according to the disclosure. Further, the disclosure may be applied even to different steering modes, but is not limited to a load-balancing mode.

In addition to the method of the third embodiment, the fourth embodiment may further include providing, by the UPF, data information to the NWDAF through the SMF.

In step 1101, a PCF 1120 may recognize necessity of policy control and charging rules determination. Specifically, the PCF 1120 may determine that the quality required by the quality of service experience of an application is not satisfied in an MA PDU session using an ATSSS load-balancing mode. For example, using the ATSSS load-balancing mode, application data may be transmitted in the ratio of 3GPP access path X % and non-3GPP access path Y %. In case that the service quality level promised by an application service provider and a core network operator is not satisfied in at least one of the above-described access paths, the PCF 1120 may re-determine the parameter of the ATSSS load-balancing mode by using the network analysis function (1130). As an index of the service quality level, a mean opinion score (MOS) may be used.

In step 1102, the PCF 1120 may request the network data analysis for the quality of service experience of an application from NWDAF 1130. The PCF 1120 may request the analysis of the quality of service experience for each access type. The request may include an analytics identifier (ID) and analytics filter information. The value of the analytics ID may include a service experience. The analytics filter information may include an application identifier (ID) and access type(s). The access type may include a 3GPP access type and/or non-3GPP access type. The request in step 1102 may be transferred through an Analytics Info Request or Analytics Subscription Subscribe message.

The NWDAF 1130 may measure the quality of service experience for each QoS profile being used for application data transmission. The NWDAF 1130 may collect network data obtained through measurement of the quality of service experience from SMF 1140, UPF 1150, and AF.

The operations in steps 1105 to 1109 may be performed by the AF instead of the UPF 1150. In case that the UPF 1150 performs the operation, the NWDAF 1130 may collect the access performance measurement result for downlink data of the application data, that is, the data being transmitted from the UPF 1150 to the UE. In case that the AF performs the operation, the NWDAF 1130 may collect the access performance measurement result for uplink data of the application data, that is, the data being transmitted from the UE to the AF. In case that the NWDAF 1130 collects the network data from the AF, steps 1105 to 1109 may be performed through the NEF between the NWDAF 1130 and the AF.

In step 1103, the NWDAF 1130 may request the SMF 1140 to provide the network data related to a QoS flow allocated to the application. This request may include an event ID, and the value of the event ID may include QoS Allocation. The request may be transferred through an event exposure subscribe message.

In step 1104, the SMF 1140 may notify the NWDAF 1130 of a list of QoS flow identifiers (QFI) being used to transmit the application data. This notification may be transferred through an event exposure notify message.

The NWDAF 1130 may request information from the UPF 1150 through the SMF 1140. First, a case that the NWDAF 1130 determines to request the information from the UPF 1150 through the SMF 1140 may be as follows. In step 1102, a case that the UPF managing the user plane of the MA PDU session that becomes the target of the PCF request is unable to be determined may be included. Further, in step 1102, a case that there are one or more UPFs managing the user plane of the MA PDU session that becomes the target of the PCF request may be included. In step 1105, in case that the NWDAF 1130 determines to request the information from the UPF 1150 through the SMF 1140, the NWDAF 1130 may request the SMF 1140 to provide the network data related to the access performance measurement of the application data. The request may include the event ID, and the event ID value may include the access performance measurement. The request may be transferred through the event exposure subscribe message. Further, the request may be separately transmitted, but the embodiment of the disclosure is not limited thereto.

When the NWDAF 1130 requests the SMF 1140 to provide the network data related to the access performance measurement of the application data, the NWDAF 1130 may provide information about an indicator (hereinafter, for convenience, direct report indication) for requesting the UPF 1150 to directly provide the network data to the NWDAF 1130.

The SMF 1140 having received the network data providing request related to the data access performance measurement may select the UPF for the MAPDU session that becomes the target of data collection requested by the NWDAF 1130.

In step 1106, the SMF 1140 may request the UPF 950 to provide (or transfer) the network data related to the data access performance measurement. The request may be transferred through the event exposure subscribe message. Further, in case of receiving the information about the direct report indication from the NWDAF 1130, the SMF 1140 may transfer the information about the direct report indication to the UPF. Even if the SMF 1140 has not received the direct report indication from the NWDAF 1130, the SMF 1140 may provide the direct report indication to the UPF 1150 in accordance with determination of the SMF and/or another NF, or another network entity.

The UPF 1150 may measure the bit rate and/or packet delay of the QoS flow for each access type through the PMF. For example, the PMF of the UPF 1150 may measure the RTT delay with respect to one or more QoS flows being applied to the 3GPP access path, and may measure the RTT delay with respect to one or more QoS flows being applied to the non-3GPP access path. Thereafter, the measured values may be notified the NWDAF 1130. As another example, the PMF of the UPF 1150 may measure the packet loss rate with respect to one or more QoS flows being applied to the 3GPP access path, and may measure the packet loss rate with respect to one or more QoS flows being applied to the non-3GPP access path.

In step 1107, the UPF 1150 may provide the measurement result to the NWDAF 1130 through the SMF 1140. In step 1107, the UPF 1150 may transmit the transmission performance measurement result for each access of the application data to the SMF 1140. The transmission may be transferred through the event exposure notify message.

In step 1108, the SMF 1140 may transmit (or transfer) the transmission performance measurement result for each access of the application data to the NWDAF 1130. The transmission may be transferred through the event exposure notify message. In step 1109, the UPF 1150 may directly provide the measurement result to the NWDAF 1130. The measurement result may include the transmission performance measurement result for each access of the application data. The case that the UPF 1150 determines to directly provide the measurement result to the NWDAF 1130 may include a case that the UPF 1150 receives the direct report indication, or the direct report indication is determined based on the determination of the UPF and/or another NF, or another network entity. The transmission of the measurement result may be transferred through the event exposure notify message.

However, steps 1107 to 1109 are prepared to help understanding of the disclosure, and the scope of the disclosure is not limited thereto or is bound by order.

In step 1110, the NWDAF 1130 may perform analysis of the application based on the network data collected in steps 1105 to 1109. In this analysis, the deep reinforcement learning model as described above with reference to FIG. 3 may be applied.

In step 1109, the NWDAF 1130 may provide the network data analysis result for the quality of service experience of the application to the PCF 1120. In this case, the analysis result may be the analysis result for an appropriate data traffic ratio for each access type, and may be the estimated result that means it is appropriate to transmit the application traffic in the ratio of 3GPP access type Z % and non-3GPP access type W % for a predetermined time. The notification in step 1111 may be transferred through an Analytics Info Response or Analytics Subscription Notify message.

In step 1112, the PCF 1120 may determine the policy control and charging rules for the ATSSS load-balancing mode to be applied to the application data transmission based on the received analysis result. For example, in case that the estimation result, which means that it will be appropriate to transmit the application traffic in the ratio of 3GPP access type Z % and non-3GPP access type W % for a predetermined time, is received, the ATSSS load-balancing mode attribute value can be set in the ratio of 3GPP access type Z % and non-3GPP access type W % as MA PDU session control information.

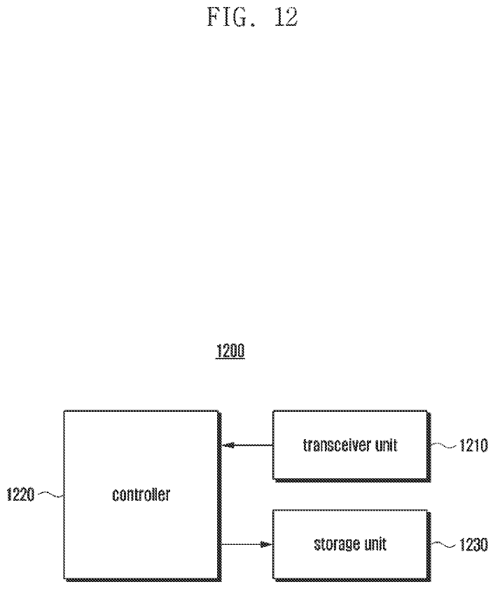

FIG. 12 is a diagram illustrating the structure of a UE according to an embodiment of the disclosure.

With reference to FIG. 12,
UE may include a transceiver unit 1210, a controller 1220, and a storage unit 1230. In the disclosure, the controller is a physical constitution, and may be defined as a circuit or application-specific integrated circuit or at least one processor. The constituent elements as described above with reference to FIGS. 1 to 11 may be hierarchically mounted on a hardwired constitution.

The transceiver unit 1210 may transmit or receive a signal to or from another network entity. For example, the transceiver unit 1210 may receive system information from a base station, and may receive a synchronization signal or a reference signal. The transceiver unit 1210 may include an antenna, a modem or a communication processor, and an RF module. The antenna may take an appropriate form for the band for communicating with the (R)AN of the 5G network, and may include one or more antennas. Further, in order to provide the ATSSS function, the transceiver unit 1210 according to the disclosure may further include a constitution for communicating with another network in addition to the 5G network. For example, the transceiver unit 1210 may further have the constitution for communicating with a Wi-Fi type access point. Further, the transceiver 1210 may include a modem or a communication processor, and may process (encode/modulate) and transmit signal/message/data in accordance with a communication network protocol. In contrast, the transceiver unit 1210 may reversely process (decode/demodulate) the signal/message/data received from a specific network. The RF module may have constitutions for performing band-up conversion or band-down conversion of the signal/message/data to a specific band, performing analog/digital conversion and/or digital/analog conversion of the received data, and performing low-noise filtering and power amplification.

The controller 1220 may control the overall operation of the UE according to an embodiment proposed in the disclosure. For example, the controller 1220 may control a signal flow between blocks so as to perform an operation according to the above-described flowchart. Specifically, the controller 1220 may control the operation proposed in the disclosure in order to receive remaining system information (RMSI) in a multi-beam based system according to an embodiment of the disclosure. The controller 1220 may include at least one processor, and may perform the operation based on various kinds of data/signals received from the UE transceiver unit 1210, and if needed, may store the data in the storage unit 1230. Further, the controller 1220 may control the operation described in the disclosure based on the data stored in the storage unit 1230. Further, the controller 1220 may control the storage unit 1230 to store, delete, update, and call the data, and may control the transceiver unit 1210.

The storage unit 1230 may store therein at least one of information transmitted or received through the transceiver unit 1210 and information generated through the controller 1220. For example, the storage unit 1230 may store scheduling information related to RMSI transmission, and RMSI-related PDCCH time axis location and cycle information. The storage unit 1230 may store data required to control the UE and/or data generated during the control, and may store various data intended to be stored by a user. Further, the storage unit 1230 may store specific values and/or information as described above in the disclosure, and may store control data required for the operation according to the disclosure.

In addition to the above-described constitutions, the UE may include more constituent elements. For example, the UE may include an input module and an output module for a user interface. As an example of the input module and the output module, an input/output module in the form of a touchscreen may be included. Moreover, the UE may further include various kinds of sensors. The constituent elements that may be included in the UE according to the disclosure are not specially restricted.

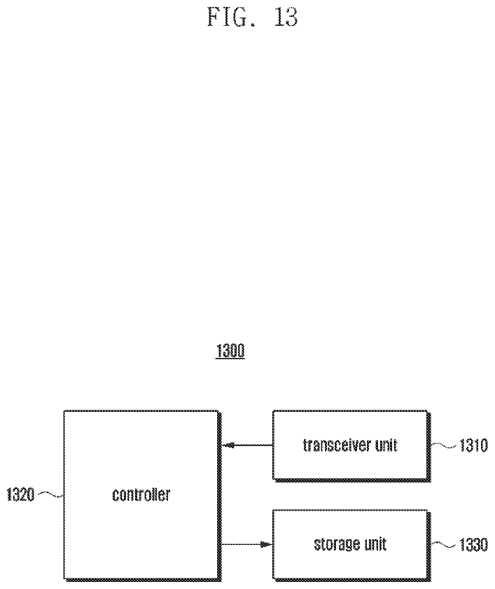

FIG. 13 is a diagram illustrating the structure of a device capable of implementing NF according to an embodiment of the disclosure.

With reference to FIG. 13, each NF as described above with reference to FIGS. 1 to 11 may include a transceiver unit 1310 for transmission and reception with at least one other NF, a controller 1320, and a storage unit 1330. In the disclosure, the controller 1320 may be defined as a circuit or application-specific integrated circuit or at least one processor.

The transceiver unit 1310 may transmit or receive a signal to or from another network entity. For example, the transceiver unit 1310 may transmit system information to a UE, and may transmit a synchronization signal or a reference signal. The transceiver unit 1310 (or network interface) may provide a predefined type interface with another NF or various types of interfaces for providing information as described above in the disclosure, and based on this, the transceiver unit 1310 may perform transmission and reception of data/signal/information/message with another NF.

The controller 1320 may control the overall operation of the base station according to an embodiment proposed in the disclosure. For example, the controller 1320 may control a signal flow between blocks so as to perform an operation according to the above-described flowchart. Specifically, the controller 1320 may control the operation proposed in the disclosure in order to receive remaining system information (RMSI) in a multi-beam based system according to an embodiment of the disclosure. The controller 1320 may be implemented by using at least one processor, and may drive a control program for controlling the operation according to the disclosure.

The storage unit 1330 may store therein at least one of information transmitted or received through the transceiver unit 1310 and information generated through the controller 1320. For example, the storage unit 1330 may store scheduling information related to RMSI transmission, and RMSI-related PDCCH time axis location and cycle information. The storage unit 1330 may temporarily store control data generated by the controller, or may store all or at least a part of the information as described above with reference to FIGS. 1 to 11. Further, various storage media may be used as such a memory. For example, the memory may be implemented by a hard disk, floppy disk, optical disk, ROM, and RAM, and there is no restriction on other different types of memories.

In addition to the UE and the base station, each device included in the network system (e.g., AMF, SMF, NWDAF, PCF, or UPF) may include the transceiver unit, the controller, and the storage unit.

In the above-described detailed embodiments of the disclosure, the elements included in the disclosure may be expressed in the singular or plural form depending on the proposed detailed embodiment. However, the singular or plural expression has been selected suitably for a situation proposed for convenience of description, and the disclosure is not limited to the singular or plural elements. Although an element has been expressed in the plural form, it may be configured in the singular form. Although an element has been expressed in the singular form, it may be configured in the plural form.

On the other hand, the embodiments of the disclosure disclosed in the specification and drawings as described above are merely to present specific examples in order to facilitate the explanation of the contents of the disclosure and to help understanding of the disclosure, but are not intended to limit the scope of the disclosure. Accordingly, it should be interpreted that in addition to the embodiments disclosed herein, all modifications or modified forms derived based on the technical idea of the disclosure are included in the scope of the disclosure.

Description of symbols

| | |
|---|---|
| 10: UE | 11: MPTCP functionality |
| 12: ATSSS-LL functionality | 20: RAN |
| 110: UPF | 111: MPTCP proxy functionality |
| 112, 401, 513: UPF-PMF | 113, 413, 501: UE-PMF |
| 120: AMF | 130: SMF |
| 140: PCF | 150: AF |
| 160: AUSF | 170: UDM |
| 180: DN | 190: NSSF |
| 195: NSSAAF | 196: NSACF |
| 210: 3GPP access | 220: non-3GPP access |
| 411, 511: path selector | 412, 512: steering agent |
| 420, 601, 702: NWDAF | |
| 421, 521: analysis agent | |

1. A method performed by a first entity for performing a policy control function (PCF) in a wireless communication system, the method comprising:
detecting a need for determination of a policy control function with respect to the first entity;
transmitting data analysis information request message for determination of the policy control function to a second entity configured to perform a network data analytics function (NWDAF) based on the detection result;
receiving data analysis information from the second entity; and
determining the policy control function based on the data analysis information,
wherein the data analysis information is determined based on a data access type.

2. The method of claim 1, wherein a case that the determination of the policy control function is needed comprises a case that at least one data traffic is transmitted by using different accesses (access traffic steering, switching, splitting, ATSSS, and load balancing mode) and a case that a predetermined quality of service level is not satisfied in at least one access path.

3. The method of claim 2, wherein changing the policy control function comprises determining policy control and charging rules in the ATSSS load balancing mode.

4. A method performed by a third entity for performing a user plane function (UPF) in a wireless communication system, the method comprising:
receiving a data transmission performance request message from a second entity configured to perform a network data analytics function (NWDAF);

1. A method performed by a first entity for performing a policy control function (PCF) in a wireless communication system, the method comprising:
detecting a need for determination of a policy control function with respect to the first entity;
transmitting data analysis information request message for determination of the policy control function to a second entity configured to perform a network data analytics function (NWDAF) based on the detection result;
receiving data analysis information from the second entity; and
determining the policy control function based on the data analysis information,
wherein the data analysis information is determined based on a data access type.

2. The method of claim 1, wherein a case that the determination of the policy control function is needed comprises a case that at least one data traffic is transmitted by using different accesses (access traffic steering, switching, splitting, ATSSS, and load balancing mode) and a case that a predetermined quality of service level is not satisfied in at least one access path.

3. The method of claim 2, wherein changing the policy control function comprises determining policy control and charging rules in the ATSSS load balancing mode.

4. A method performed by a third entity for performing a user plane function (UPF) in a wireless communication system, the method comprising:
receiving a data transmission performance request message from a second entity configured to perform a network data analytics function (NWDAF);
obtaining a result of data transmission performance measurement; an
transmitting the result of data transmission performance measurement to the second entity,
wherein the data transmission performance is determined based on a data access type.

5. The method of claim 4, wherein the data transmission performance comprises performance information for at least one quality of service (Qos) flow included in a data access path.

6. The method of claim 4, wherein the performance information for the at least one QoS flow comprises at least one data round-trip delay time (round-trip time, RTT, and delay) and a packet loss rate measurement value.

7. A method performed by a second entity for performing a network data analytics function (NWDAF) in a wireless communication system, the method comprising:
receiving a data analysis information request message for changing a policy control function (PCF) from a first entity configured to perform the policy control function;
transmitting a data transmission performance request message to a third entity configured to perform a user plane function (UPF) based on the data analysis information request message;
receiving a result of data transmission performance measurement from the third entity; and
transmitting data analysis information to the first entity based on the result of data transmission performance measurement,
wherein the data analysis information and the data transmission performance are determined based on a data access type.

8. The method of claim 7, further comprising generating the data analysis information based on the data transmission performance,
wherein the data transmission performance includes performance information for at least one quality of service (QOS) flow included in a data access path.

9. A first entity for performing a policy control function (PCF) in a wireless communication system, the first entity comprising:
a transceiver configured to transmit and receive a signal; and
a controller connected to the transceiver,
wherein the controller is configured to: detect a need for determination of a policy control function with respect to the first entity, transmit data analysis information request message for determination of the policy control function to a second entity configured to perform a network data analytics function (NWDAF) based on the detection result, receive data analysis information from the second entity; and determine the policy control function based on the data analysis information, wherein the data analysis information is determined based on a data access type.

10. The first entity of claim 9, wherein a case that the determination of the policy control function is needed comprises a case that at least one data traffic is transmitted by using different accesses (access traffic steering, switching, splitting, ATSSS, and load balancing mode) and a case that a predetermined quality of service level is not satisfied in at least one access path.

11. The first entity of claim 10 wherein the controller is configured to control determination of policy control and charging rules in the ATSSS load balancing mode.

12. A third entity for performing a user plane function (UPF) in a wireless communication system, the third entity comprising:
a transceiver configured to transmit and receive a signal; and
a controller connected to the transceiver,
wherein the controller is configured to: receive a data transmission performance request message from a second entity configured to perform a network data analytics function (NWDAF), obtaining a result of data transmission performance measurement, and transmit the result of data transmission performance measurement to the second entity, wherein the data transmission performance is determined based on a data access type.

13. The third entity of claim 12, wherein the data transmission performance comprises performance information for at least one quality of service (Qos) flow included in a data access path, and
wherein the performance information for the at least one QoS flow includes at least one data round-trip delay time (round-trip time, RTT, and delay) and a packet loss rate measurement value.

14. A second entity for performing a network data analytics function (NWDAF) in a wireless communication system, the second entity comprising:
a transceiver configured to transmit and receive a signal; and
a controller connected to the transceiver,
wherein the controller is configured to: receive a data analysis information request message for changing a policy control function (PCF) from a first entity configured to perform the policy control function, transmit a data transmission performance request message to a third entity configured to perform a user plane function (UPF) based on the data analysis information request message, receive a result of data transmission performance measurement from the third entity, and transmit data analysis information to the first entity based on the result of data transmission performance measurement, wherein the data analysis information and the data transmission performance are determined based on a data access type.

15. The second entity of claim 14, wherein the controller is configured to control generation of the data analysis information based on the data transmission performance, and
wherein the data transmission performance includes performance information for at least one quality of service (QOS) flow included in a data access path.
